(19) United States
(12) Patent Application Publication
(10) Pub. No.: US 2015/0163342 A1
(43) Pub. Date: Jun. 11, 2015

(54) CONTEXT-AWARE FILTER FOR PARTICIPANTS IN PERSISTENT COMMUNICATION

(71) Applicant: SEARETE LLC, Bellevue, WA (US)

(72) Inventors: Mark A. Malamud, Seattle, WA (US); Paul G. Allen, Mercer Island, WA (US); Edward K.Y. Jung, Bellevue, WA (US); Royce A. Levien, Lexington, MA (US); John D. Rinaldo, Jr., Bellevue, WA (US)

(21) Appl. No.: 14/590,841

(22) Filed: Jan. 6, 2015

Related U.S. Application Data
(63) Continuation-in-part of application No. 10/927,842, filed on Aug. 27, 2004, now Pat. No. 8,977,250.
Application No. 10/927,842 is a continuation-in-part of application No. 10/909,962, filed on Jul. 30, 2004.
Application No. 10/909,962 is a continuation-in-part of application No. 12/584,277, filed on Sep. 2, 2009.
Application No. 12/584,277 is a continuation-in-part of application No. 14/010,124, filed on Aug. 26, 2013.
Application No. 14/010,124 is a continuation-in-part of application No. 10/909,253, filed on Jul. 30, 2004, now Pat. No. 8,521,828.

(51) Int. Cl. H04M 1/725

(52) U.S. Cl. CPC H04M 1/72569

(57) ABSTRACT

A processing device local context is determined, and a communication of the processing device is filtered at least in part according to the local context.

If an Application Data Sheet (ADS) has been filed on the filing date of this application, it is incorporated by reference herein. Any applications claimed on the ADS for priority under 35 U.S.C. §§119, 120, 121 or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 U.S.C. §119(e) for provisional patent applications, for any and all parent, grandparent, great-grandparent, etc. applications of the Priority Application(s)).

### Priority Applications:

1. For purposes of the USPTO extra-statutory requirements, the present application constitutes a continuation in part of currently co-pending United States patent application entitled Context-Aware Filter for Participants in Persistent Communication, naming Mark A. Malamud, Paul G. Allen, Royce A. Levien, John D. Rinaldo, and Edward K. Y. Jung as inventors, U.S. application Ser. No. 10/927,842 filed Aug. 27, 2004, which is currently co-pending, or is an application of which a currently co-pending application is entitled to the benefit of the filing date.

2. For purposes of the USPTO extra-statutory requirements, the present application constitutes a continuation in part of currently co-pending U.S. patent application entitled Cue-Aware Privacy Filter for Participants in Persistent Communications, naming Mark A. Malamud, Paul G. Allen, Royce A. Levien, John D. Rinaldo, and Edward K. Y. Jung as inventors, U.S. application Ser. No. 10/909,962 filed Jul. 30, 2004, which is currently co-pending, or is an application of which a currently co-pending application is entitled to the benefit of the filing date.

3. For purposes of the USPTO extra-statutory requirements, the present application constitutes a continuation in part of currently co-pending U.S. patent application entitled Cue-Aware Privacy Filter for Participants in Persistent Communications, naming Paul G.

Allen, Edward K. Y. Jung, Royce A. Levien, Mark A. Malamud, and John D. Rinaldo, and as inventors, U.S. application Ser. No. 12/584,277 filed Sep. 2, 2009, which is currently co-pending, or is an application of which a currently co-pending application is entitled to the benefit of the filing date.

4. For purposes of the USPTO extra-statutory requirements, the present application constitutes a continuation in part of currently co-pending U.S. patent application entitled THEMES INDICATIVE OF PARTICIPANTS IN PERSISTENT COMMUNICATION, naming Mark A. Malamud, Paul G. Allen, Royce A. Levien, John D. Rinaldo, and Edward K. Y. Jung, and as inventors, U.S. application Ser. No. 14/010,124 filed Aug. 26, 2013, which is currently co-pending, or is an application of which a currently co-pending application is entitled to the benefit of the filing date.

5. For purposes of the USPTO extra-statutory requirements, the present application constitutes a continuation in part of currently co-pending U.S. patent application entitled THEMES INDICATIVE OF PARTICIPANTS IN PERSISTENT COMMUNICATION, naming Mark A. Malamud, Paul G. Allen, Royce A. Levien, John D. Rinaldo, and Edward K.Y. Jung, and as inventors, U.S. application Ser. No. 10/909,253 filed Jul. 30, 2004, which is currently co-pending, or is an application of which a currently co-pending application is entitled to the benefit of the filing date.

The U.S. Patent and Trademark Office (USPTO) has published a notice to the effect that the USPTO's computer program require that patent applications both reference a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listing of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and of any and all parent, grandparent, great-grandparent, etc. applications of the Priority Applications, including any priority claims, is incorporated herein by reference to the extent such subject matter is not inconsistent herewith.

### TECHNICAL FIELD

The present disclosure relates to inter-device communication.

### BACKGROUND

Modern communication devices are growing increasingly complex. Devices such as cell phones and laptop computers now often are equipped with cameras, microphones, and other sensors. Depending on the context of a communication (e.g. where the person using the device is located and to whom they are communicating, the date and time of day, among possible factors), it may not always be advantageous to communicate information collected by the device in its entirety, and/or unaltered.

People increasingly interact by way of networked group communication mechanisms. Mechanisms of this type include chat rooms, virtual environments, conference calls, and online collaboration tools.

Group networked environments offer many advantages, including the ability to bring together many individuals in a collaborative fashion without the need for mass group travel to a common meeting place. However, group networked environments often fall short in one important aspect of human communication: richness. It may be challenging to convey certain aspects of group interaction that go beyond speech. For example, the air of authority that a supervisor or other organization superior conveys in a face-to-face environment may be lacking in a networked environment. As another example, a networked group interaction may fail to convey the many subtle and not-so-subtle expressions of mood that may accompany proximity, dress, body language, and inattentiveness in a group interaction.

### SUMMARY

The following summary is intended to highlight and introduce some aspects of the disclosed embodiments, but not to limit the scope of the invention. Thereafter, a detailed description of illustrated embodiments is presented, which will permit one skilled in the relevant art to make and use aspects of the invention. One skilled in the relevant art can obtain a full appreciation of aspects of the invention from the subsequent detailed description, read together with the figures, and from the claims (which follow the detailed description).

A local communication context for a device is determined, communication of the device is filtered at least in part according to the local context. Some aspects that may help determine the local context include identifying at least one functional object of the local context, such as a machine, control, tool, fixture, appliance, or utility feature; identifying at least one of a designated area or zone, proximity to other devices or objects or people, or detecting a presence of a signal or class of signals (such as a short range or long range radio signal); identifying a sound or class of sound to which the device is exposed, such as spoken words, the source of spoken words, music, a type of music, conversation, traffic sounds, vehicular sounds, or sounds associated with a service area or service establishment; sounds of human activity, animal sounds, weather sounds, or other nature sounds.

Filtering the communication of the processing device may involve altering a level, pitch, tone, or frequency content of sound information of the communication of the processing device, and/or removing, restricting, or suppressing sound information of the communication. Filtering may include substituting pre-selected sound information for sound information of the communication.

The local context may be determined at least in part from images obtained from the local environment, such as one or more digital photographs. Filtering communication of the processing device may include altering the intensity, color content, shading, lighting, hue, saturation, reflectivity, or opacity of visual information of the communication of the processing device, and/or removing, reducing, restricting, or suppressing visual information of the communication of the processing device. Visual information of the communication may be restricted to one or more sub-regions of a camera field. Filtering may include substituting pre-selected visual information for visual information of the communication.

A remote communication context for the device may be determined, and communication of the device filtered according to the remote context. Determining a remote communication context for the processing device may include identifying an attribute of a caller, such as an identity of the caller, determined via such manners as caller's phone number or other communication address, the caller's membership in a group, organization, or other entity, or the caller's level of authority.

A device communication is filtered according to an identified cue. The cue can include at least one of a facial expression, a hand gesture, or some other body movement. The cue can also include at least one of opening or closing a device, deforming a flexible surface of the device, altering an orientation of the device with respect to one or more objects of the environment, or sweeping a sensor of the device across the position of at least one object of the environment. Filtering may also take place according to identified aspects of a remote environment.

Filtering the device communication can include, when the device communication includes images/video, at least one of including a visual or audio effect in the device communication, such as blurring, de-saturating, color modification of, or snowing of one or more images communicated from the device. When the device communication includes audio, filtering the device communication comprises at least one of altering the tone of, altering the pitch of, altering the volume of, adding echo to, or adding reverb to audio information communicated from the device.

Filtering the device communication may include substituting image information of the device communication with predefined image information, such as substituting a background of a present location with a background of a different location. Filtering can also include substituting audio information of the device communication with predefined audio information, such as substituting at least one of a human voice or functional sound detected by the device with a different human voice or functional sound.

Filtering may also include removing information from the device communication, such as suppressing background sound information of the device communication, suppressing background image information of the device communication, removing a person's voice information from the device communication, removing an object from the background information of the device communication, and removing the image background from the device communication.

An auditory theme is presented representing at least one participant in a networked group interaction, and reflecting an attribute of that participant. The theme may reflect an interaction status of the participant. The theme may represent the participant's status in the interaction, status in an organization, an interaction context of the at least one participant, or at least one attribute of the at least one participant.

Further aspects are recited in relation to the Figures and the claims.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of an inter-device communication arrangement.

FIG. 2 is a block diagram of an embodiment of a process to affect a filter applied to device communication.

FIG. 3 is a block diagram of an embodiment of a process to substitute pre-selected information in a device communication.

FIG. 4 is a flow chart of an embodiment of a process to determine a filter to apply to device communication according to a local communication context.

FIG. 5 is a flow chart of an embodiment of a process to determine a filter to apply to device communication according to a local and remote communication context.

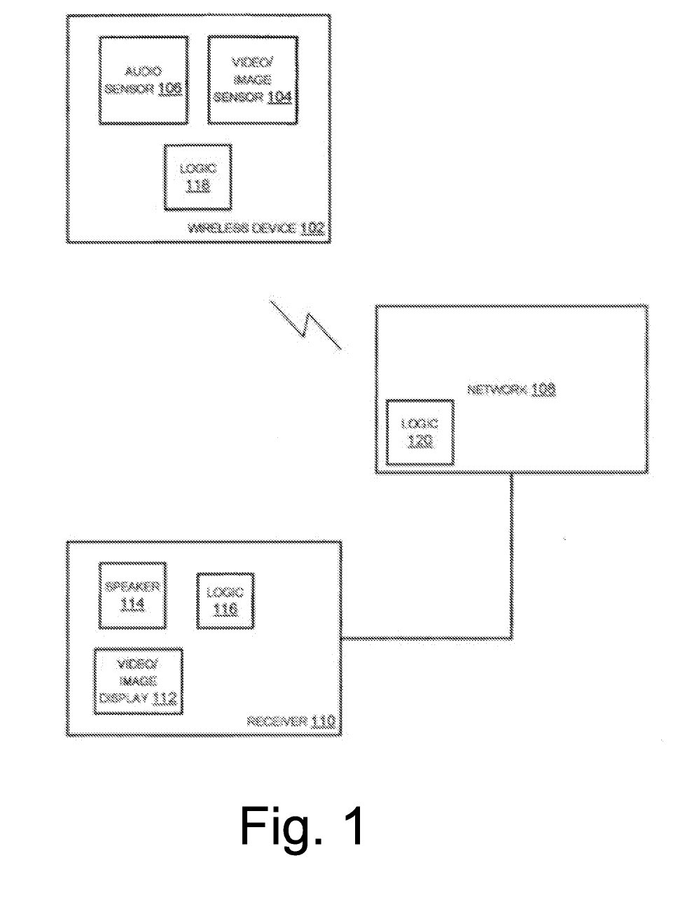

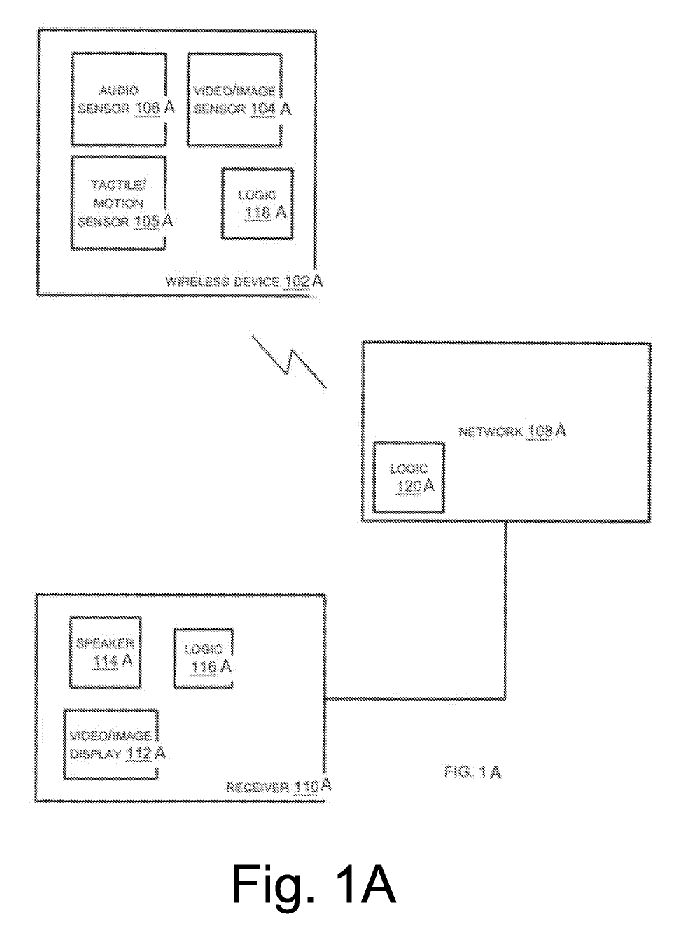

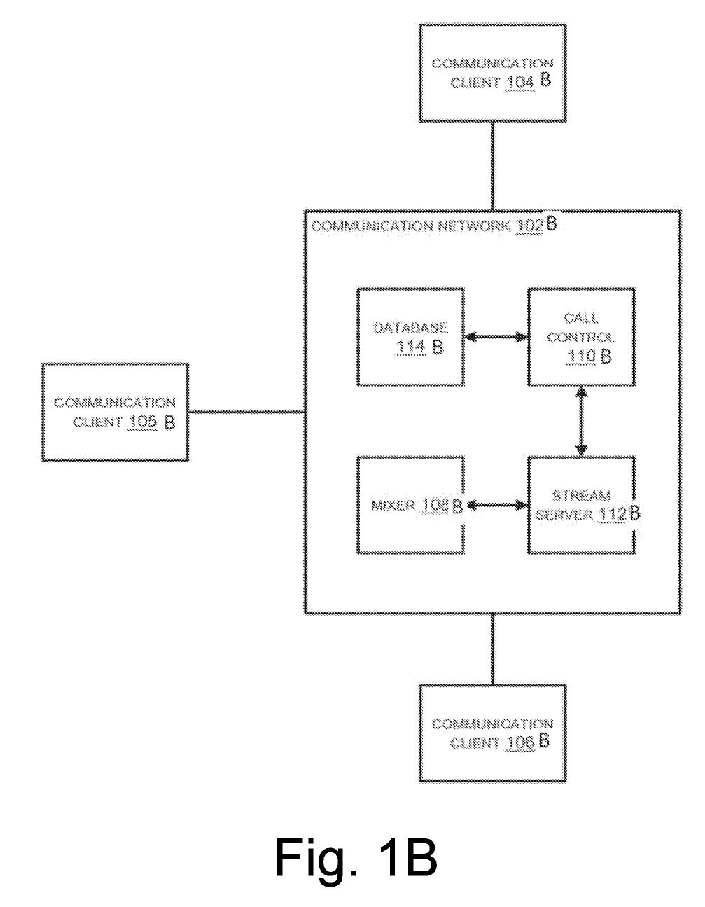

FIG. 1A is a block diagram of an embodiment of a device communication arrangement.

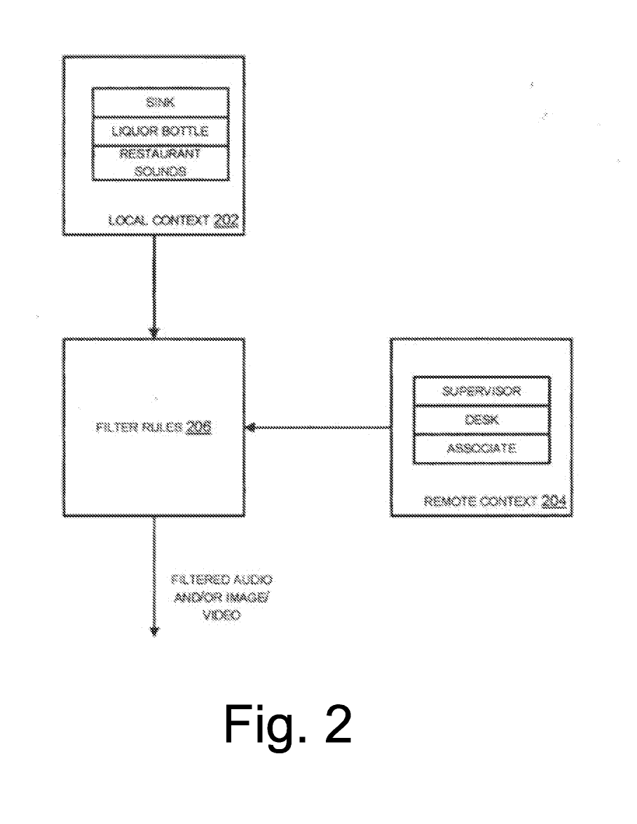

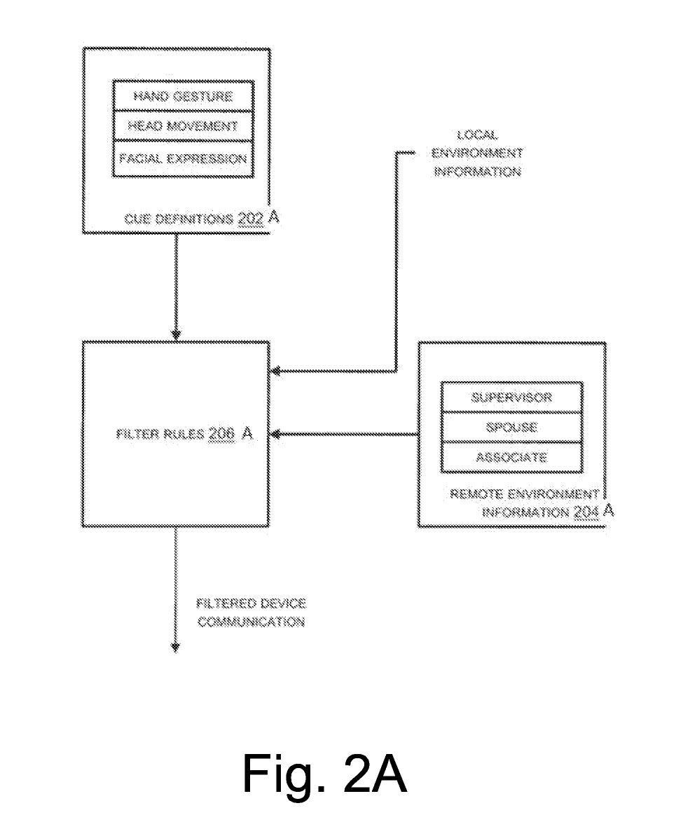

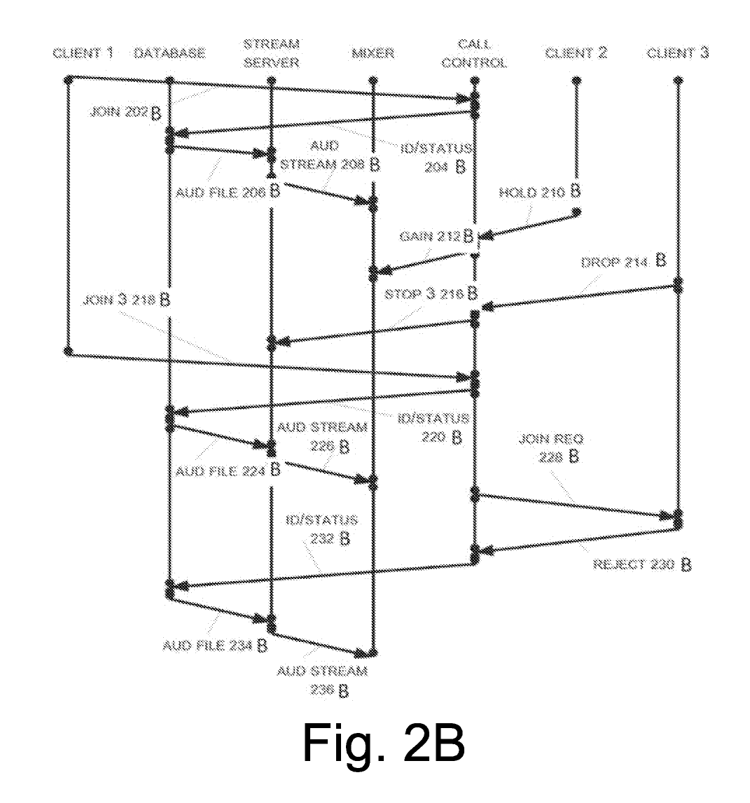

FIG. 2A is a block diagram of an embodiment of an arrangement to produce filtered device communications.

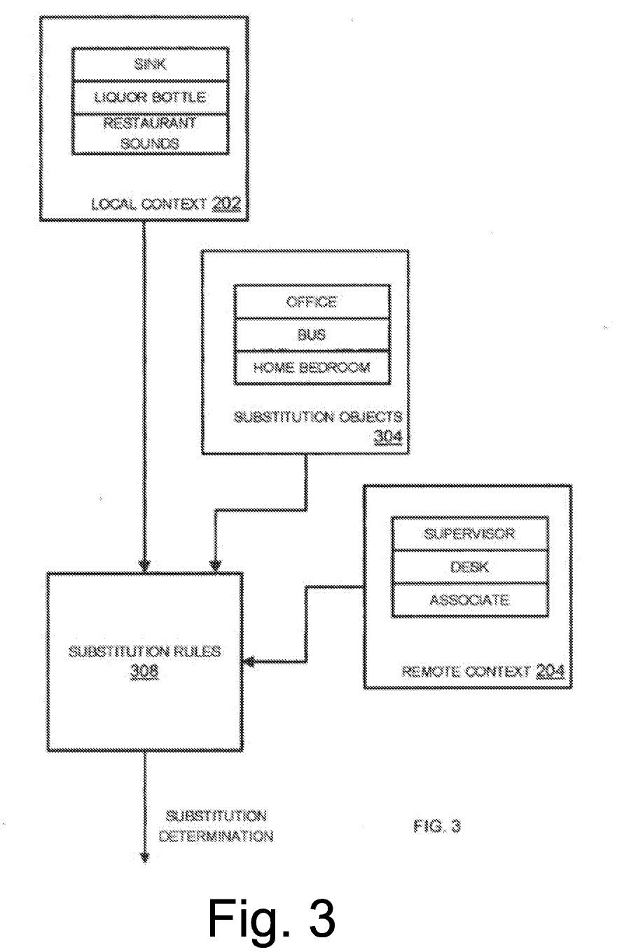

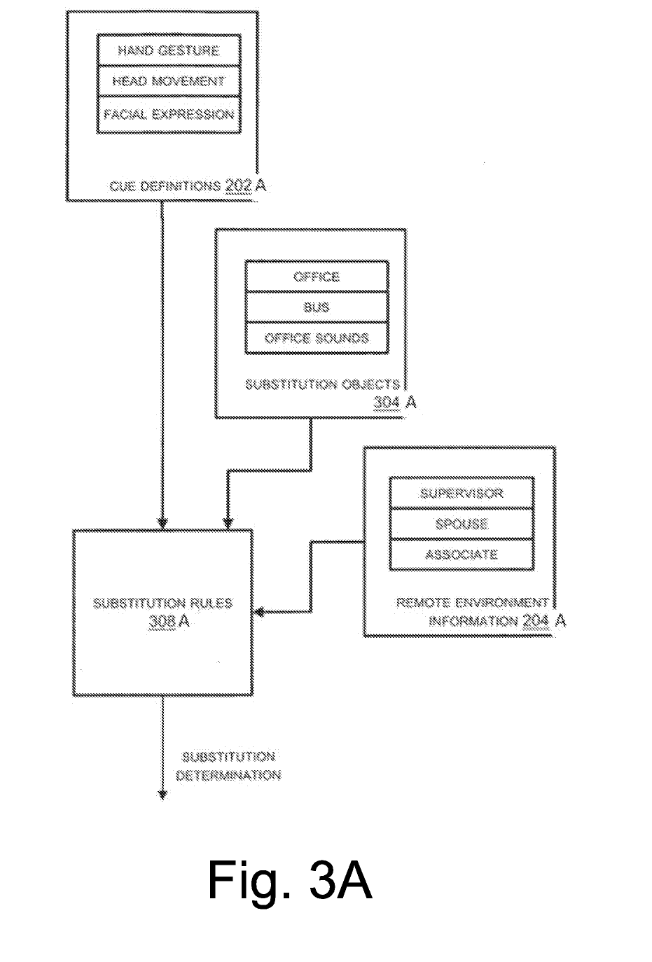

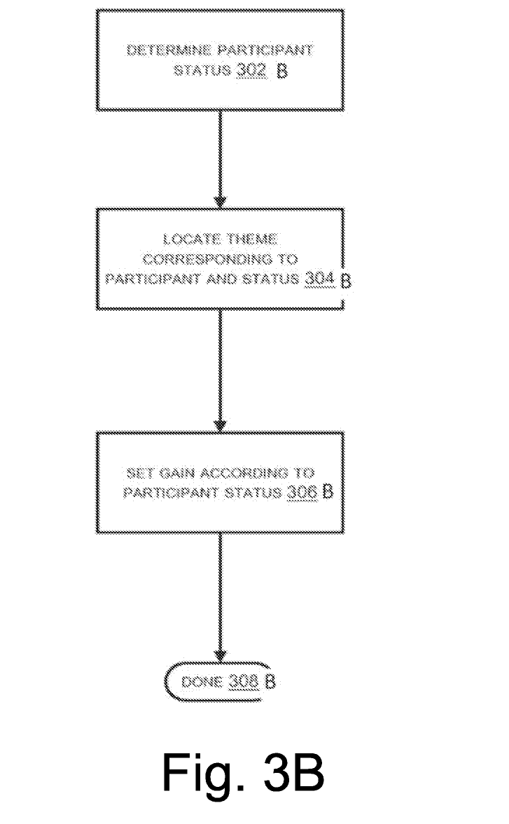

FIG. 3A is a block diagram of another embodiment of a device communication arrangement.

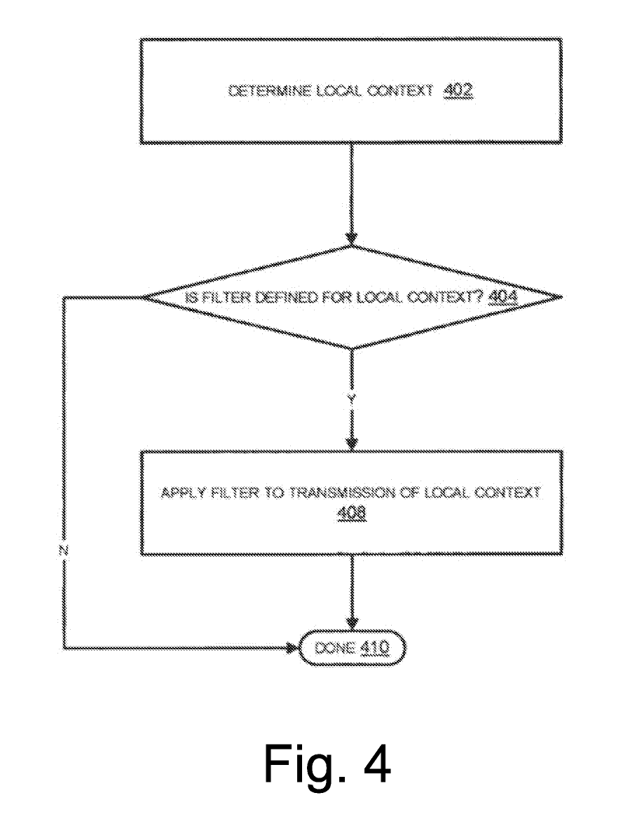

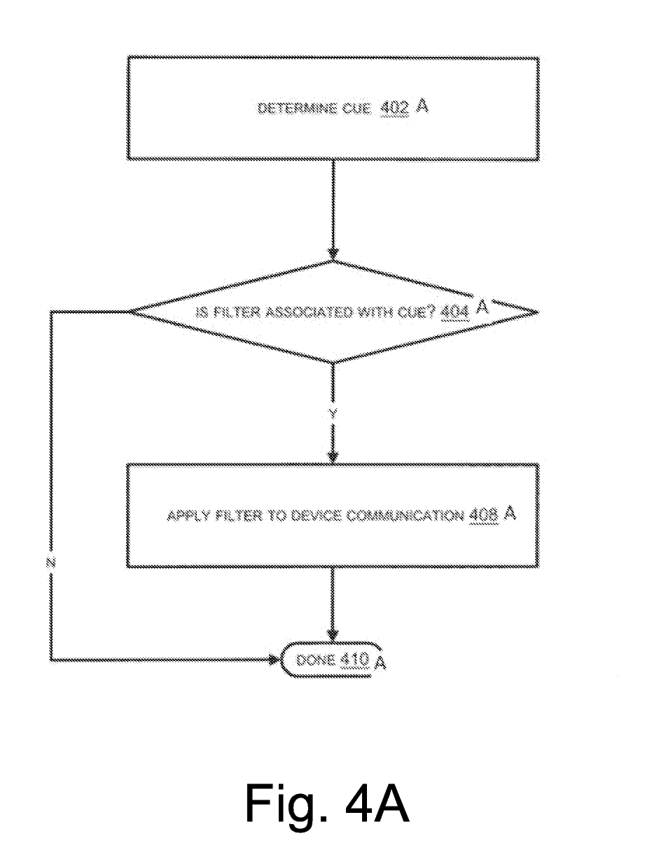

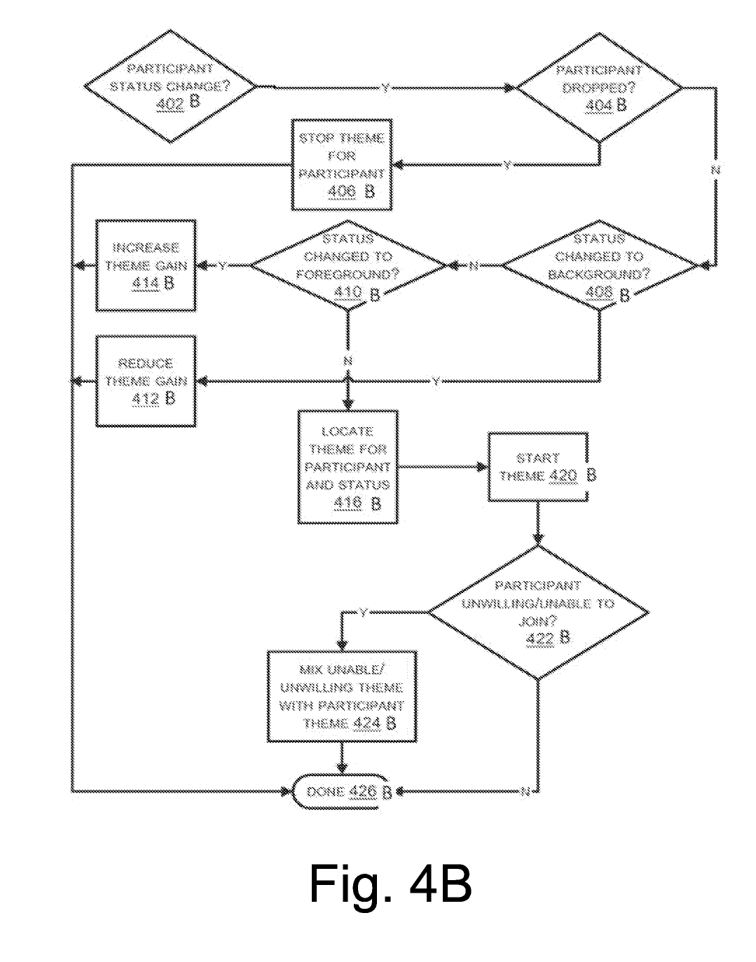

FIG. 4A is a flow chart of an embodiment of a method of filtering device communications according to a cue.

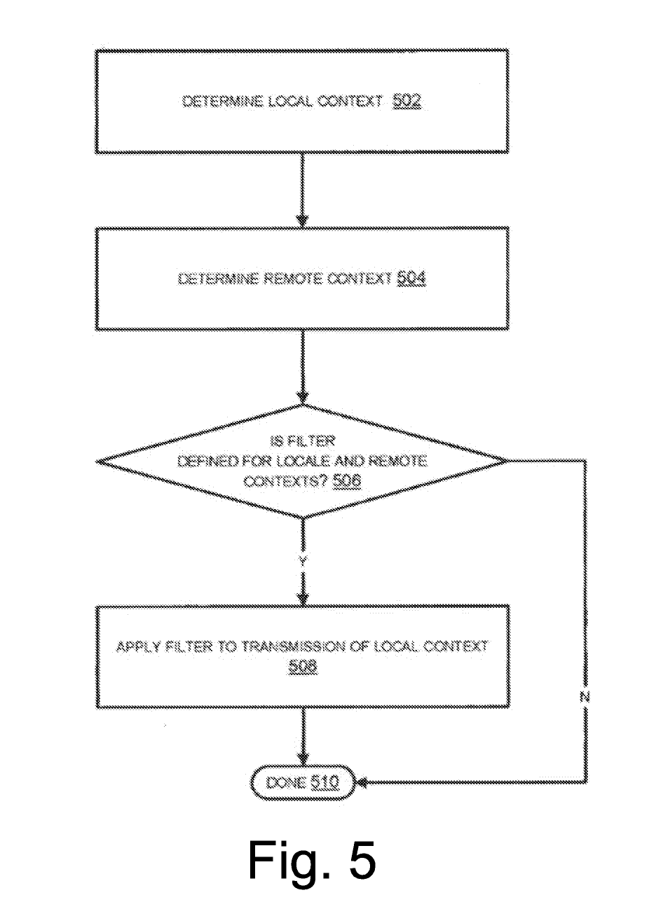

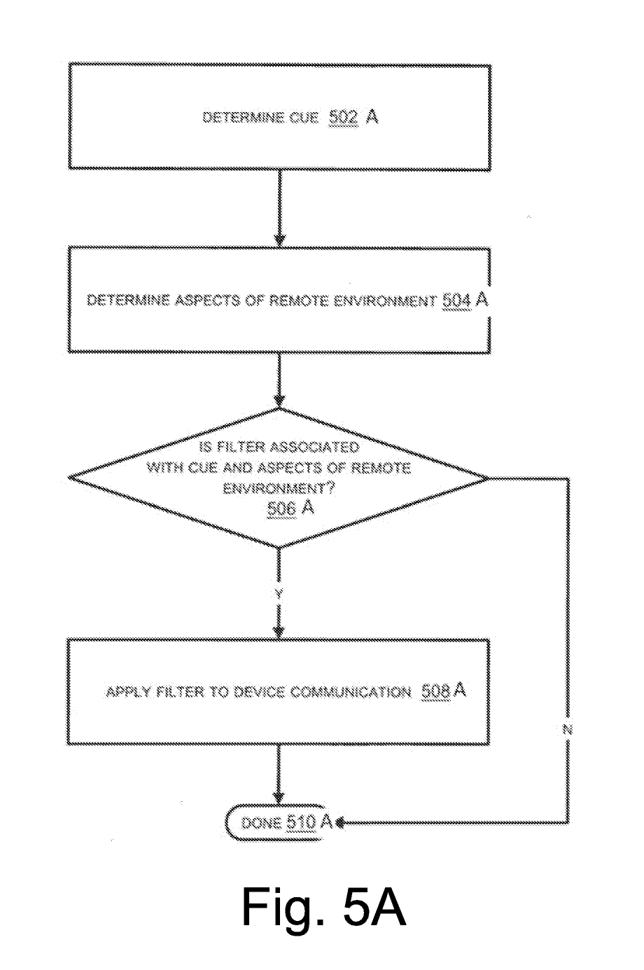

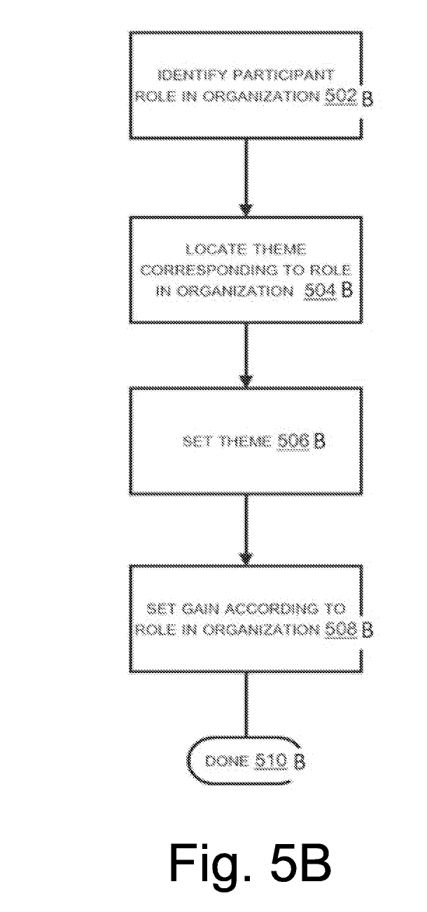

FIG. 5A is a flow chart of an embodiment of a method of filtering device communications according to a cue and a remote environment.

FIG. 1B is a block diagram of an embodiment of a networked group communication environment.

FIG. 2B is an action diagram of an embodiment of a method of providing an audible theme for a participant in networked group communication.

FIG. 3B is a flow chart of an embodiment of a method of determining a theme for a participant in networked group communication.

FIG. 4B is also a flow chart of an embodiment of a method of determining a theme for a participant in networked group communication.

FIG. 5B is a flow chart of an embodiment of a method of determining a theme for a participant in networked group communication according to a role of the participant in an organization.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention. References to “one embodiment” or “an embodiment” do not necessarily refer to the same embodiment, although they may.

FIG. 1 is a block diagram of an embodiment of an inter-device communication arrangement. A wireless device 102 comprises a video/image sensor 104, an audio sensor 106, and logic 118. The video/image sensor 104 senses visual information of the environment of the wireless device, enabling communication from the wireless device that includes visual information (e.g. a camera and/or video enabled phone). The audio sensor 106 (e.g. a microphone) senses sound information of the device's local environment, enabling communication of sound information from the wireless device. The logic 118 defines processing operations of the wireless device 102. The wireless device 102 is in wireless communication with a network 108, by way of which it may communicate with remote devices such as receiver 110. The receiver 110 may be any device capable of communicating with the wireless device 102. Examples include another wireless device, a personal computer, a personal digital assistant, a television, and so on. The receiver 110 comprises a video/image display 112 for displaying visual information received from the wireless device 102,a speaker 114 to render sound information received from the wireless device 102, and logic 116 to define processing operations of the receiver 110.

The receiver 110 is shown coupled to the network 108 via wired mechanisms, such as conventional telephone lines or wired broadband technologies such as Digital Subscriber Line and cable, in order to illustrate a variety of communication scenarios. However the receiver 110 could of course be coupled to the network 108 via wireless technologies.

The camera (image sensor 106) and/or microphone 106 of the wireless device 102 may be employed to collect visual information and sounds of a local context of the wireless device 102. Visual and/or sound information communicated from the wireless device 102 to the remote device 110 may be altered, restricted, removed, or replaced, according to the visual information and/or sounds of the local context. Furthermore, visual and/or sound information communicated from the wireless device 102 to the remote device 110 may be altered, restricted, removed, or replaced, according to aspects of a remote context of the remote device 110. For example, an identity of a caller associated with the remote device 110 may be ascertained, for example by processing a voice of the caller. According to the identity of the caller, at least one of the visual information and sound of output signals of the wireless device 102 may be restricted. These and other aspects of the communication arrangement are additionally described in conjunction with FIGS. 2-5.

FIG. 2 is a block diagram of an embodiment of a process to affect a filter applied to device communication. A local context 202 for a device comprises various objects, including a sink, a liquor bottle, and restaurant sounds. Based upon this information, it may be ascertained that the person carrying the device is in a restaurant, night club, or drinking establishment. The device may then receive a call. A remote context for the communication includes a supervisor of the called party, a desk, and an associate of the called party. Based upon this information, it may be ascertained that the call originates from on office where the called party works. The called party, not wanting to be identified in a restaurant, bar, or other entertainment facility during work hours, may not want the caller to become aware of the various sounds and objects of his local environment. The remote context and local context may be applied to filter rules 206, which the person has configured to remove certain information from his device's communications under these circumstances. The filter rules 206 may remove, suppress, restrict, or otherwise filter background undesirable sounds and/or visual information of the local establishment, so that the called party's compromising location is not revealed to the caller.

Thus, a local communication context for a device is determined according to factors of the local environment the device is operating in. Context factors may include functional objects of the local context, such as a machine, control (lever, switch, button, etc.), tool, fixture, appliance, or utility feature (e.g. a mop, broom, pipes, etc.). Context factors may also include identifying a designated area or zone that the device is operating in, determining proximity of the device to other devices or objects or people, or detecting a presence of a signal or class of signals. A signal or class of signals may include a wireless signal conforming to a known application, such as a short range or long range radio signal (e.g. Bluetooth™ signals).

The local context may be determined at least in part by sounds or classes of sounds to which the device is exposed. Examples of sounds or classes of sounds include spoken words, the source of spoken words, music, a type of music, conversation, traffic sounds, vehicular sounds, or sounds associated with a service area or service establishment (e.g. sounds of glassware, sounds of latrines, etc.). Other sounds or class of sound include at least one sound of human activity, animal sounds, weather sounds, or other nature sounds.

The local context may be at least partially determined from images obtained from the local environment. For example, one or more digital photographs of the device environment may be processed to help determine the local context. Images, sounds, and other signals may be processed to help determine at least one device or person in proximity to the processing device.

Communication signals directed from the processing device to a remote device may be filtered at least in part according to the local context. Filtering may include altering a level, pitch, tone, or frequency content of sound information (e.g. digital audio) of the communication of the processing device. Filtering may include removing, restricting, or suppressing sound information of the communication of the processing device (e.g. omitting or suppressing particular undesirable background sounds). Intensity, color content, shading, lighting, hue, saturation, reflectivity, or opacity of visual information (e.g. digital images and video) of the communication. Filtering may include removing, reducing, restricting, or suppressing visual information of the communication of the processing device (e.g. removing or suppressing background visual information). For example, if the processing device includes a camera, the camera feed to the remote device may be restricted to one or more sub-regions of the camera field, so as to omit undesirable background information.

The remote communication context may also provide important information that may be relevant to filtering the communication signals of the processing device. The remote communication context is the environment/context in which the remote device is operating. Determining a remote communication context may include identifying an attribute of a caller, such as an identity of the caller. Examples of an identity of the caller include the caller's phone number or other communication address, the caller's membership in a group, organization, or other entity, or the caller's level of authority (e.g. is the caller a boss, an employee, an associate, etc.), or some other attribute of the caller. Examples of caller attributes include the caller's age, gender, location, emotional or physical state of the caller, or how the caller is related to the party operating the processing device (e.g. is the caller a spouse, a child, etc.).

Determining a remote communication context may include processing an image obtained from the remote context, for example to perform feature extraction or facial or feature recognition. Sound information obtained from the remote context may be processed to perform voice recognition, tone detection, or frequency analysis. Images, sounds, or other information of the remote context may be processed to identify a functional object of the remote context (see the discussion preceding for examples of functional objects), and/or to identify at least one device or person proximate to the remote device.

Communication signals of the processing device may then be filtered according to at least one of the local and the remote contexts.

FIG. 3 is a block diagram of an embodiment of a process to substitute pre-selected information in a device communication. Various substitution objects 304 are available to apply to the device communication. For example the substitution objects 304 may include visual and sound information for an office, a bus, or a home bedroom. Based upon information ascertained from the local and/or remote communication contexts, the substitution rules 308 may select from among the substitution objects to make substitution determinations that affect the device communications. For example, based upon the called party being in a bar, and the caller being the boss, the substitution rules may determine to replace the visual background and sounds of the bar with visuals and sounds of the called party's home bedroom. Thus, the called party may appear to the caller to be home sick in bed. As another example, a caller may be located in a train station and make a call on his cell-phone. The station may include a lot of background noise that is undesirable to transmit with the call, but it might be useful, depending on the context, to transmit (and/or transform) some part of the information that is present in the station environment. If the target of the call is a casual business colleague, a generic “travel” ambient sound may be conveyed in place of the background station noise that simply conveys the fact that the caller is on the road. However, when calling a close colleague or family member, a travel theme may be presented in place of the background noise that indicates the city the traveler is in, while preserving the background announcement that the train is boarding.

Thus, filtering communication of the device may include substituting pre-selected sound or image information for information of the communication, for example, substituting pre-selected office sounds for sounds of a drinking establishment, or substituting pre-selected visuals for images and/or video communicated by the device.

FIG. 4 is a flow chart of an embodiment of a process to determine a filter to apply to device communication according to a local communication context. At 402 a local context of a communication device is determined.

If at 404 a filter is defined for the local context and/or aspects thereof, the filter is applied at 408 to communications of the device, to alter communicated features of the local context (e.g. to remove indications of the place, people that around, and so on). At 410 the process concludes.

FIG. 5 is a flow chart of an embodiment of a process to determine a filter to apply to device communication according to local and/or remote communication contexts. At 502 the local context and/or features thereof are determined. At 504 the remote context and/or features thereof are determined. If at 506 a filter is defined for aspects of the locale and/or remote contexts, the filter is applied to communications of the device at 508. At 510 the process concludes.

FIG. 1A is a block diagram of an embodiment of a device communication arrangement. A wireless device 102A comprises logic 118A, a video/image sensor 104A, an audio sensor 106A, and a tactile/motion sensor 105A. A video/image sensor (such as 104A) comprises a transducer that converts light signals (e.g. a form of electromagnetic radiation) to electrical, optical, or other signals suitable for manipulation by logic. Once converted, these signals may be known as images or a video stream. An audio sensor (such as 106A) comprises a transducer that converts sound waves (e.g. audio signals in their original form) to electrical, optical, or other signals suitable for manipulation by logic. Once converted, these signals may be known as an audio stream. A tactile/motion sensor (such as 105A) comprises a transducer that converts contact events with the sensor, and/or motion of the sensor, to electrical, optical, or other signals suitable for manipulation by logic. Logic (such as 116A, 118A, and 120A) comprises information represented in device memory that may be applied to affect the operation of a device. Software and firmware are examples of logic. Logic may also be embodied in circuits, and/or combinations of software and circuits.

The wireless device 102A communicates with a network 108A, which comprises logic 120A. As used herein, a network (such as 108A) is comprised of a collection of devices that facilitate communication between other devices. The devices that communicate via a network may be referred to as network clients. A receiver 110A comprises a video/image display 112A, a speaker 114A, and logic 116A. A speaker (such as 114A) comprises a transducer that converts signals from a device (typically optical and/or electrical signals) to sound waves. A video/image display (such as 112A) comprises a device to display information in the form of light signals. Examples are monitors, flat panels, liquid crystal devices, light emitting diodes, and televisions. The receiver 110A communicates with the network 108A. Using the network 108A, the wireless device 102A and the receiver 110A may communicate.

The device 102A or the network 108A identify a cue, either by using their logic or by receiving a cue identification from the device 102A user. Device 102A communication is filtered, either by the device 102A or the network 108A, according to the cue. Cues can comprise conditions that occur in the local environment of the device 102A, such as body movements, for example a facial expression or a hand gesture. Many more conditions or occurrences in the local environment can potentially be cues. Examples include opening or closing the device (e.g. opening or closing a phone), the deforming of a flexible surface of the device 102A, altering of the device 102A orientation with respect to one or more objects of the environment, or sweeping a sensor of the device 102A across at least one object of the environment. The device 102A, or user, or network 108A may identify a cue in the remote environment. The device 102A and/or network 108A may filter the device communication according to the cue and the remote environment. The local environment comprises those people, things, sounds, and other phenomenon that affect the sensors of the device 102A. In the context of this figure, the remote environment comprises those people, things, sounds, and other signals, conditions or items that affect the sensors of or are otherwise important in the context of the receiver 110A.

The device 102A or network 108A may monitor an audio stream, which forms at least part of the communication of the device 102A, for at least one pattern (the cue). A pattern is a particular configuration of information to which other information, in this case the audio stream, may be compared. When the at least one pattern is detected in the audio stream, the device 102A communication is filtered in a manner associated with the pattern. Detecting a pattern can include detecting a specific sound. Detecting the pattern can include detecting at least one characteristic of an audio stream, for example, detecting whether the audio stream is subject to copyright protection.

The device 102A or network 108A may monitor a video stream, which forms at least part of a communication of the device 102A, for at least one pattern (the cue). When the at least one pattern is detected in the video stream, the device 102A communication is filtered in a manner associated with the pattern. Detecting the pattern can include detecting a specific image. Detecting the pattern can include detecting at least one characteristic of the video stream, for example, detecting whether the video stream is subject to copyright protection.

FIG. 2A is a block diagram of an embodiment of an arrangement to produce filtered device communications. Cue definitions 202A comprise hand gestures, head movements, and facial expressions. In the context of this figure, the remote environment information 204A comprise a supervisor, spouse, and associates. The filter rules 206A define operations to apply to the device communications and the conditions under which those operations are to be applied. The filter rules 206A in conjunction with at least one of the cue definitions 202A are applied to the local environment information to produce filtered device communications. Optionally, a remote environment definition 204A may be applied to the filter rules 206A, to determine at least in part the filter rules 206A applied to the local environment information.

Filtering can include modifying the device communication to incorporate a visual or audio effect. Examples of visual effects include blurring, de-saturating, color modification of, or snowing of one or more images communicated from the device. Examples of audio effects include altering the tone of, altering the pitch of, altering the volume of, adding echo to, or adding reverb to audio information communicated from the device.

Filtering can include removing (e.g. suppressing) or substituting (e.g. replacing) information from the device communication. Examples of information that may suppressed as a result of filtering include the background sounds, the background image, a background video, a person's voice, and the image and/or sounds associated with an object within the image or video background. Examples of information that may be replaced as a result of filtering include background sound information which is replaced with potentially different sound information and background video information which is replaced with potentially different video information. Multiple filtering operations may occur; for example, background audio and video may both be suppressed by filtering. Filtering can also result in application of one or more effects and removal of part of the communication information and substitution of part of the communication information.

FIG. 3A is a block diagram of another embodiment of a device communication arrangement. The substitution objects 304A comprise office, bus, and office sounds. The substitution objects 304A are applied to the substitution rules 308 along with the cue definitions 202A and, optionally, the remote environment information 204A. Accordingly, the substitution rules 308A produce a substitution determination for the device communication. The substitution determination may result in filtering.

Filtering can include substituting image information of the device communication with predefined image information. An example of image information substitution is the substituting a background of a present location with a background of a different location, e.g. substituting the office background for the local environment background when the local environment is a bar.

Filtering can include substituting audio information of the device communication with predefined audio information. An example of audio information substitution is the substituting at least one of a human voice or functional sound detected by the device with a different human voice or functional sound, e.g. the substitution of bar background noise (the local environment background noise) with tasteful classical music.

FIG. 4A is a flow chart of an embodiment of a method of filtering device communications according to a cue. At 402A it is determined that there is a cue. If at 404A it is determined that no filter is associated with the cue, the process concludes. If at 404A it is determined that a filter is associated with the cue, the filter is applied to device communication at 408A. At 410A the process concludes.

FIG. 5A is a flow chart of an embodiment of a method of filtering device communications according to a cue and a remote environment. At 502A it is determined that there is a cue. At 504A at least one aspect of the remote environment is determined. If at 506A it is determined that no filter is associated with the cue and with at least one remote environment aspect, the process concludes. If at 506A it is determined that a filter is associated with the cue and with at least one remote environment aspect, the filter is applied to device communication at 508A. At 510A the process concludes. FIG. 1B is a block diagram of an embodiment of a networked group communication environment. The communication network 102B comprises mixer logic 108B, call control logic 110B, streaming logic 112B, and a database 114B. “Logic” refers to signals and/or information that may be applied to affect the operation of a device. Software and firmware are examples of logic. Logic may also be embodied in circuits, and/or combinations of software and circuits. Clients 104B, 105B, 106B are devices that communicate with and by way of the communication network 102B. Some examples of communications clients are personal computers (PCs), personal digital assistants (PDAs), laptop computers, and wireless telephones. A communication network comprises one more devices cooperating to enable communication between clients of the network, and may additionally provide services such as chat, email, and directory assistance. Examples of networks include the Internet, intranets, and public and private telephone networks. The mixer 108B combines signals representing sounds. The call control 1108 provides for establishment, termination, and control of connections between the clients 102B,104B,106B and the network 102B. The stream server 112B provides to the clients 102B,104B,106B information streams representing auditory signals (e.g. sounds). The database 114B comprises collection(s) of information and/or associations among information. Each of these elements is presented in this embodiment as included within the network 102B. However, alternative embodiments may locate various of these elements in the communications clients. Also, some of the functions provided by these elements may reside within the network, but particular communication clients may comprise similar capabilities and may use local capabilities instead of the network functionality.

The clients 102B,104B,106B may be employed in a networked group interaction, such as a conference call, chat room, virtual environment, online game, or online collaboration environment. Auditory themes may be presented representing the participants of the interaction. The auditory theme may include one or more tones, one or more songs, one or more tunes, one or more spoken words, one or more sound clips, or one or more jingles, to name just some of the possibilities.

Various effects may be applied to the theme to reflect the participant's interaction status or other attributes. For example, the gain, tempo, tone, key, orchestration, orientation or distribution of sound, echo, or reverb of the theme (to name just some of the possible effects) may be adjusted to represent an interaction status or attribute of the participant. Examples of participant attributes are the participant's role or status in an organization, group, association of individuals, legal entity, cause, or belief system. For example, the director of an organization might have an associated auditory theme that is more pompous, weighty, and serious than the theme for other participants with lesser roles in the same organization. To provide a sense of gravitas, the theme might be presented at lower pitch and with more echo.

Examples of a participant's group interaction status include joined status (e.g. the participant has recently joined the group communication), foreground mode status (e.g. the participant “has the floor” or is otherwise actively communicating), background mode status (e.g. the participant has not interacted actively in the communication for a period of time, or is on hold), dropped status (e.g. the participant has ceased participating in the group interaction), or unable to accept communications status (e.g. the participant is busy or otherwise unable to respond to communication).

Another aspect which may determine at least in part the participant's auditory theme is the participant's interaction context. The interaction context includes a level of the participant's interaction aggression (e.g. how often and/or how forcefully the participant interacts), virtual interaction proximity of the participant to the other participants, or a role of the participant in the interaction. By virtual interaction proximity is meant some form of location, which may be an absolute or relative physical location such as geographic location or location within a building or room or with respect to the other participants. As an example of the latter, if all of the participants are at one location in Phoenix except for one who is in Washington D.C., the distance between that individual and the rest of the group participants may be reflected in some characteristic of his auditory theme. Alternatively or additionally, it may be a virtual location such as a simulated location in the interaction environment. For example, when a group is playing a game over a network, one of the participants may be (virtually) in a cave, while the others are (virtually) in a forest. The virtual locations of the individual participants may be reflected in some characteristics of their auditory themes.

Another aspect which may determine at least in part the participant's auditory theme is at least one attribute of the participant. Attributes comprise a participant's age (e.g. a child might have a lighter, more energetic theme), gender, location, recognition as an expert, education level (such as PhD, doctor), membership in a group or organization, or physical attributes such as a degree of deafness (e.g. the auditory theme might be made louder, simpler, or suppressed). The auditory theme may be presented in an ongoing fashion during the participant's participation in the interaction. Alternatively or additionally, the auditory signal may be presented in a transitory fashion in response to an interaction event. Examples of an interaction event include non-auditory events, such as interaction with a control or object of the interaction environment. An on-going auditory theme may have transitory themes interspersed within its presentation. FIG. 2B is an action diagram of an embodiment of a method of providing an audible theme for a participant in networked group communication. Participants join, drop off, rejoin, and reject participation in the group communication, among other things. During these interactions, an auditory signal (i.e. theme) is set for a networked group interaction which may comprise an indication of an available status of at least one participant of the group. For example, when one potential participant in the group communication rejects participation, at least one theme associated with that participant may reflect a busy signal. At 202B communication client 1, associated with a first participant, provides a request to join the networked group interaction. At 204B and 206B the call control looks up and retrieves from the database an audio theme representing that the first participant in particular has joined the interaction. At 208B this theme is mixed with other themes for other participants.

At 210B a second communication client, associated with a second participant, provides an indication that the second participant has gone “on hold”. At 212B the call control sets a gain for the second participant's theme, corresponding to the second participant being “on hold”. Thus, the audible signal presented to the other communication participants in association with the second participant indicates that the second participant is now on hold. An example of such indication might be presentation of an attenuated theme for the second participant.

At 214B a third communication client, associated with a third participant, drops out of the group interaction. At 216B the call control ceases presentation of the audible theme associated with the third participant.

At 218B the first participant attempts to rejoin the third participant with the group interaction. At 220B and 224B the call control looks up and retrieves an audio theme representing that the third participant is being rejoined to the group interaction. At 226B the stream server mixes this audio theme with the themes for the other participants. However, when at 228B the call control attempts to rejoin the third participant with the interaction, the third participant rejects the attempt at 230B. At 232B and 234B the call control looks up and retrieves an audio theme indicating that the third participant has rejected the attempt to join him (or her) with the interaction. This audio theme may in some embodiments reflect a busy signal. At 236B the theme for the third participant is mixed with the themes for the other participants.

FIG. 3B is a flow chart of an embodiment of a method of determining a theme for a participant in a networked group interaction. At 302B a participant status is determined. At 304B a theme corresponding to the participant and status is determined. At 306B the signal gain (e.g. volume) for the theme is set at least in part according to the participant status. The resulting auditory signal includes at least one theme indicative of an attention status of at least one participant of the networked group interaction. The attention status is indicative of the level of participation in the group communication. Indications of attention level include number, length, loudness, and frequency of responses to communication by others; whether or not the participant is on hold; whether or not the participant has dropped; and whether or not the participant responds to questions. At 308B the process concludes.

Of course, this is merely one example of either selecting or adjusting a theme according to a participant and some aspect or attribute of that participant. FIG. 4B is also a flow chart of an embodiment of a method of determining a theme for a participant in networked group communication. The theme volume characteristics are modified to reflect the availability status of the participant.

If at 402B the participant status has changed, a check is made at 404B to determine if the participant has dropped out of the group interaction. If the participant has dropped, the theme for the participant is stopped at 406B. If the participant has not dropped, a check is made at 408B to determine if the participant's status has changed to a “background” mode, which is a less interactive status such as “on hold”. If the participant status has changed to background, the theme gain for the participant is reduced at 412B.

If the participant has not changed to a background status, a check at 410B determines if the participant now has a foreground status, which is an active participation status, for example, perhaps the participant “has the floor” and is speaking or otherwise providing active communication in the interaction. If so, the gain for the participant's theme is increased at 414B. In some situations, it may be suitable to stop, suppress, or otherwise attenuate the theme of the active speaker, and/or the non-active speakers, so as not to interfere with spoken communications among the participants. A result is an ongoing, device-mediated interaction among multiple participants, wherein a richer amount of information relating to attributes of the participants is conveyed via ongoing and transient themes particular to a participant (or group of participants) and attributes thereof.

At 416B a theme is located corresponding to the participant and status. The theme is started at 420B. If at 422B the participant is unwilling/unable to join, an unable/unwilling theme (such as a busy signal) is mixed at 424B with the participant's selected theme as modified to reflect his status. At 426B the process concludes.

FIG. 5B is a flow chart of an embodiment of a method of determining a theme for a participant in networked group communication according to a role of the participant in an organization. The role of a participant in the group interaction may reflect their role in an organization, or may be unrelated. For example, a secretary in a business may assume the role of group moderator in a networked group interaction. At least one theme determined in this manner may be reflected in the final auditory signals presented to at least one group communication participant. At 502B a participant's role, position, or status in an organization is identified. One method of identifying the participants role, position, or status is from information of an organization chart. At 504B a theme is located corresponding at least in part to the participant's role, status, or position in the organization. At 506B the theme is set. At 508B a gain for the theme (e.g. determining the volume) is set at least in part according to the participant's role, position, or status in the organization. For example, if one of the group participants is head of a product group, and another is her secretary acting in the role of transcriber, the gain for the product group head may be set such that her theme is has higher volume than her secretary's theme. At 5108 the process concludes. Again, this is merely one example of setting a theme and/or theme effect according to an attribute of the participant.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

1-69. (canceled)

70. A method comprising:
identifying a cue; and
filtering a device communication according to the cue.

71. The method of claim 70, wherein the cue comprises at least one of:
a facial expression, a verbal or nonverbal sound, a hand gesture, or some other body movement.

72. The method of claim 70, wherein the cue comprises at least one of:
opening or closing a phone, deforming a flexible surface of the device, altering an orientation of the device with respect to one or more objects of the environment, or sweeping a sensor of the device across the position of at least one object of the environment.

73. The method of claim 70 further comprising:
identifying a remote environment; and
filtering the device communication according to the cue and the remote environment.

74. The method of claim 70, wherein filtering the device communication comprises at least one of:
including a visual or audio effect in the device communication.

75. The method of claim 74, wherein filtering the device communication comprises at least one of:
blurring, de-saturating, color modification of, or snowing of one or more images communicated from the device.

76. The method of claim 74, wherein filtering the device communication comprises at least one of:
altering the tone of, altering the pitch of, altering the volume of, adding echo to, or adding reverb to audio information communicated from the device.

77. The method of claim 70 wherein filtering the device communication further comprises:
substituting image information of the device communication with predefined image information.

78. The method of claim 77 wherein substituting image information further comprises:
substituting a background of a present location with a background of a different location.

79. The method of claim 70 wherein filtering the device communication further comprises:
substituting audio information of the device communication with predefined audio information.

80. The method of claim 79 wherein substituting audio information further comprises:
substituting at least one of a human voice or functional sound detected by the device with a different human voice or functional sound.

81. The method of claim 70 wherein filtering the device communication further comprises:
removing information from the device communication.

82. The method of claim 81 wherein removing information from the device communication further comprises:
suppressing background sound information of the device communication.

83. The method of claim 81 wherein filtering the device communication further comprises:
suppressing background image information of the device communication.

84. The method of claim 81 wherein filtering the device communication further comprises:
removing a person's voice information from the device communication.

85. The method of claim 81 wherein filtering the device communication further comprises:
removing an object from the background information of the device communication.

86. The method of claim 81 wherein filtering the device communication further comprises:
removing the image background from the device communication.

87-102. (canceled)

103. A wireless device comprising:
at least one data processing circuit;
logic that when applied to determine the operation of the at least one data processing circuit results in the wireless device detecting a cue comprising at least one of a facial expression, gesture, or other body motion, and filtering a communication of the wireless device according to the cue.

104. The wireless device of claim 103 wherein the logic to filter the device communication further comprises:
logic that when applied to determine the operation of the at least one data processing circuit results in the wireless device suppressing background sound information of the device communication.

105. The wireless device of claim 103 wherein the logic to filter the device communication further comprises:
logic that when applied to determine the operation of the at least one data processing circuit results in the wireless device suppressing background image information of the device communication.

106. The wireless device of claim 103 wherein the logic to filter the device communication further comprises:
logic that when applied to determine the operation of the at least one data processing circuit results in the wireless device substituting a predefined background for the image background in the device communication.

107-141. (canceled)

142. A system comprising:
means for identifying a cue; and
means for filtering a device communication according to the cue.
